(19) United States
(12) Patent Application Publication
(10) Pub. No.: US 2004/0183221 A1
(43) Pub. Date: Sep. 23, 2004

(54) Method of making expandable polystyrene packaging materials

(76) Inventors: Harry Bussey JR., Marco Island, FL (US); Buddy Harry Bussey III, Atlantic Highlands, NJ (US)

Correspondence Address: Francis C. Hand, Esq., c/o Carella, Byrne, Bain, Gilfillan,, Cecchi, Stewart & Olstein, 6 Becker Farm Road, Roseland, NJ, 07068, US

(21) Appl. No.: 10/393,156

(22) Filed: Mar. 20, 2003

(51) Int. Cl. B29C 44/22; B29C 44/56

(52) U.S. Cl. 264/45.5; 264/45.9; 264/46.1; 264/143

(57) ABSTRACT

An extrudable mass of thermoplastic polystyrene and blowing agent is provided with an olefin, e.g. polyethylene, or polypropylene in an amount of from 1% to 5% by weight of the mass. The resulting pellets that are processed from the extrudate are characterized in being dust free and in having a smooth shiny skin without cracks, a sponginess greater than a conventionally made polystyrene pellet and a bulk density of less than 0.2 pounds per cubic foot.

This invention relates to a method of making expandable polystyrene loose fill flowable packaging materials.

Heretofore, various techniques have been known for making expandable polystyrene packaging loose fill flowable materials. A conventional technique is to extrude a homogeneous mass of polystyrene and blowing agent through a die into a plurality of strands that are then quenched in water in order to prevent any appreciable expansion of the strands while also forming a hard shell on the strands. The strands have then been cut into pellets, boxed and sent to a customer in the dense form. The customer then expands the pellets into a foamed state for use as loose fill packaging material. However, there are several inherent problems in manufacturing expandable polystyrene pellets of this type. In particular, when the pellets have been expanded from the latent state, cracks and grooves tend to form in the skin of the pellets. As a result, when these pellets are handled in bulk, the edges of the cracks and grooves flake and dust has been created.

Further, the pellets have been brittle and easy to break or crack. Also, when the pellets are cut, rough cut edges have resulted.

Accordingly, it is an object of the invention to eliminate the creation of dust in the manufacture and handling of expandable polystyrene pellets.

It is another object of the invention to provide expandable polystyrene pellets that are resilient and not easily broken.

It is another object of the invention to provide expandable polystyrene pellets that can be made into low density packaging elements.

It is another object of the invention to obtain foamed packaging elements of low density.

Briefly, the invention provides a method of forming latent foaming packaging elements comprising the steps of forming a flowable mass of thermoplastic polystyrene, a blowing agent and a predetermined amount of an olefin, i.e. polyethylene, or polypropylene; extruding the mass through a die into at least one continuous strand of predetermined shape; cooling the continuous strand to form a hard shell thereon and prevent appreciable expansion of the strand; and cutting the cooled strand to form a plurality of latent foaming pellets.

In accordance with the invention, the amount of polyethylene or polypropylene added to the polystyrene mass constitutes up to 20% by weight of the polystyrene depending on the melt number of the additive. In this respect, the polyethylene has a melt index of greater than 2 and preferably a melt of from #20 to #30 melt.

Preferably, for a polyethylene having a melt of from #20 to #30, the amount of polyethylene added is from 1% to 5% by weight of the polystyrene.

The higher the percentage of the additive polyethylene or polypropylene and the lower the melt number, the greater the size of the closed cell structure. As a result more difficulty is created to hold the blowing agent within the latent foaming pellets.

The polyethylene is a low density polyethylene, a medium density polyethylene, a high density polyethylene or a linear low density polyethylene.

After the pellets have been made, the pellets are boxed and shipped to a user in the dense form. Thereafter, the customer would expand the pellets in a pre-expander or the like approximately three times leaving a desired time between each expansion to cure. The expanded pellets are then ready to be used as foamed packaging material.

By adding polyethylene (or polypropylene) in small amounts to the extrudate, it has been found that dust is almost eliminated when the latent foaming pellets are later expanded. Further, it has been found that the resulting pellets are resilient, have a smooth shiny surface and do not break or crack as easily as pellets made from polystyrene. It has also been found that the cushioning value of the expanded packaging elements is increased.

The packaging elements that are made may have a bulk density of less than 0.2 pounds per cubic foot.

It has been found that the introduction of polyethylene to the polystyrene extrudate will reduce the shelf life of the pellets as the blowing agent, for example pentane, is more easily released through permeable walls of polyethylene. Thus, the amount of polyethylene that is added to the extrudate will depend upon the shelf life desired for the pellets which are produced.

In warm weather, for example, 50 plus degrees Fahrenheit, the expandable pellets may have to be refrigerated while in storage in order to keep the blowing agent in a liquid state so as not to boil and penetrate the polystyrene walls diluted with polyethylene.

These and other objects and advantages of the invention will become more apparent from the following detailed description taken in conjunction with the accompanying drawings wherein:

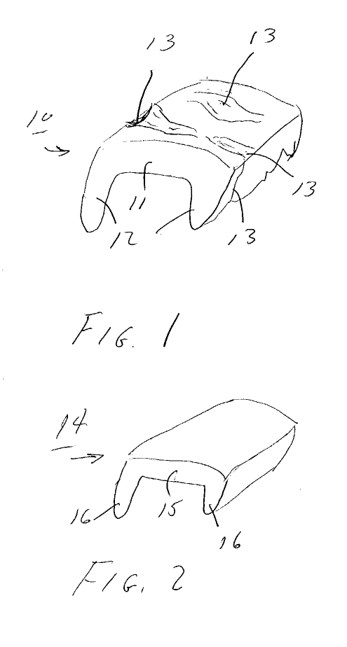

FIG. 1 illustrates a perspective view of a prior art pellet made in a conventional manner from polystyrene; and

FIG. 2. illustrates a perspective view of a pellet made in accordance with the invention.

Referring to FIG. 1, the pellet 10 has a generally block C-shape defining a body portion 11 and a pair of legs 12 that extend from opposite ends of the body portion 11. As illustrated, the body portion 11 is characterized in having a plurality of generally transverse grooves or valleys 13 that extend along the length of the body portion 11. These transverse grooves 13 arise during the foaming of the pellet 10 from a latent foaming state.

Typically, when a mass of latent foaming polystyrene pellets are foamed by a user into a state as represented in FIG. 1, the pellets 10 create a degree of dust. That is to say, as the latent foaming pellets expand, cracks and grooves form along the extruded length. These cracks and grooves have edges and surfaces that tend to flake. As a result, a small amount of dust is formed by each pellet 10. As the mass of expanded pellets are then transported from a hopper in which the pellets have been heated, the dust accumulates and blows about the equipment and environment through which the pellets are transported.

Referring to FIG. 2, a pellet 14 made in accordance with the invention has a generally block C-shape or any other suitable shape, such as an E-shape, I shape, oval shape, S-shape and the like. Where the pellet 14 has a C-shape, the pellet has a body portion 15 and a pair of legs 16 that extend from opposite ends of the body portion 15. The pellet 14 is characterized in having a skin with smooth shiny surfaces. That is, the body portion 15 has a continuous uninterrupted surface and the legs 16 have continuous uninterrupted surfaces.

The skin of the pellet 14, unlike the skin on the polystyrene pellet 10, does not crack so that dust is not created. In this respect, the addition of polyethylene to the extrudate produces a skin that contains polyethylene that, in turn, prevents cracking.

The pellet 14 also has an internal cell structure that renders the pellet spongy, i.e. spongier than the polystyrene pellet 10.

A mass of the pellets 14 has a bulk density of less than 0.2 pounds per cubic foot. This makes the mass of pellets 14 particularly suitable for use as packaging elements of loose fill type.

The following are examples of manufacturing a pellet 14 in accordance with the invention.

### EXAMPLE 1

A conventional flowable mass of thermoplastic styrene and blowing agent was formed in a suitable extruder. To this mass was added a #20 melt polyethylene in an amount of 1% by weight of the polystyrene (1% PE).

The mass was extruded through a die into a continuous strand of block C-shape, cooled to form a hard shell thereon and prevent appreciable expansion of the strand, and then cut to form a plurality of latent foaming pellets.

As the extrusion process continued over time, the percentage of additive polystyrene was increased to 1.5% after 4 hours, 2.0% after 4 hours and 3% by weight after 4 hours, all the same day.

The foamed pellets that were obtained from the first extrudate (the 1% PE) were characterized in having a smooth shiny skin without cracks, a sponginess greater than a conventionally made polystyrene pellet and a bulk density of less than 0.2 pounds per cubic foot.

The foamed pellets that were obtained from the second extrudate (the 1.5% PE) had the same characteristics as the 1% PE pellets.

The foamed pellets that were obtained from the third extrudate (the 2% PE) had the same characteristics as the 1% PE pellets.

The foamed pellets that were obtained from the fourth extrudate (the 3.0% PE) deteriorated and became crystalline with a large closed cell structure.

It was concluded that for a #20 melt polyethylene, the amount of additive should be from 1% to 2.5% by weight and not 3% or more.

### EXAMPLE 2

The same procedure was followed as in Example 1 except a #2 melt polyethylene was added in an amount of 1% by weight of the polystyrene and increased by 0.5% each succeeding 4 hours up to 2% by weight.

The foamed pellets that were obtained from the first extrudate (the 1% PE) were characterized in having a smooth shiny skin without cracks, a sponginess greater than a conventionally made polystyrene pellet and a bulk density of less than 0.2 pounds per cubic foot.

The foamed pellets that were obtained from the second extrudate (the 1.5% PE) started to deteriorate.

The foamed pellets that were obtained from the third extrudate (the 2.0% PE) deteriorated and became crystalline with a large closed cell structure.

It was concluded that for a #2 melt polyethylene, the amount of additive should be 1% and not more than 1%5.

The results of the two sets of tests indicate that the polyethylene used may be a fractional melt up to a #50 melt and that the percentage added depends on the melt. The lower the melt, the harder it is to mix the flowable mass in the extruder. That is, the lower the melt number, the higher the melt temperature. Also, the lower the melt number, the less the amount of polyethylene can be added.

The results also indicate that the amount of polyethylene added may be from 1% to 20% and that the higher the percentage of polyethylene used, the more difficult to control the cell size and blowing agent in the finished pellet.

Overall, the melt range should preferably be from #20 to #30 and the corresponding additive percentage should be from 1% to %5.

A dye may also be added to the flowable mass in the extruder to provide a color such as blue, pink, green and the like to the resulting pellets. However, the amount and type of dye added should not inhibit the formation of the product intended. By way of example, a blue dye sold under the designation VPS 81003, Blue Concentrate by Vision Plastiks & Colorants LLC of Ohio may be used in an amount of from ¼% to 5% by weight of the flowable mass depending on the intensity of the color desired.

The invention thus provides a method of making foamed pellets that does not generate dust.

Further, the invention provides a pellet that has a smooth shiny skin without interruptions, that has a resiliency greater than a conventional polystyrene pellet and a bulk density of less than 0.2 pounds per cubic foot.

What is claimed is:

1. A method of forming latent foaming packaging elements, said method comprising the steps of
forming a flowable mass of thermoplastic polystyrene, a blowing agent and a predetermined amount of additive selected from the group consisting of polyethylene and polypropylene;
extruding said mass through a die into at least one continuous strand of predetermined shape;
cooling the continuous strand to form a hard shell thereon and prevent appreciable expansion of the strand; and
cutting the cooled strand to form a plurality of latent foaming pellets.

2. A method as set forth in claim 1 wherein said amount of polyethylene constitutes less than 20% by weight of the amount of polystyrene.

3. A method as set forth in claim 1 wherein said amount of polyethylene constitutes from 1% to 5% by weight of the amount of polystyrene.

4. A method as set forth in claim 1 wherein said polyethylene is a #20 melt polyethylene in an amount of from 1% to 2.5% by weight of the amount of polystyrene.

5. A method as set forth in claim 1 wherein said polyethylene is a #2 melt polyethylene in an amount of 1% by weight of the amount of polystyrene.

6. A method as set forth in claim 1 wherein said polyethylene is selected from a #20 melt to #30 melt polyethylene and in an amount of from 1% to 20% by weight of the amount of polystyrene.

7. A method as set forth in claim 1 wherein said polyethylene has a melt number in the melt range of from #20 to #30 and is in an amount of from 1% to 5% by weight of the amount of polystyrene.

8. A method as set forth in claim 1 herein said polyethylene is a low density polyethylene.

9. A method as set forth in claim 1 herein said polyethylene is a medium density polyethylene.

10. A method as set forth in claim 1 herein said polyethylene is a high density polyethylene.

11. A method as set forth in claim 1 herein said polyethylene is a linear low density polyethylene.

12. A method of making foamed packaging elements comprising the steps of
forming a flowable mass of thermoplastic polystyrene, a blowing agent and a predetermined amount of additive selected from the group consisting of polyethylene and polypropylene;
extruding said mass through a die into at least one continuous strand of predetermined shape;
cooling the continuous strand to form a hard shell thereon and prevent appreciable expansion of the strand;
cutting the cooled strand to form a plurality of latent foaming pellets; and
thereafter heating the latent foaming pellets for a predetermined time in a series of time spaced apart steps to expand the pellets into packaging elements having a density of less than 0.2 pounds per cubic foot.

13. A method as set forth in claim 12 wherein said polyethylene is a #20 melt polyethylene in an amount of from 1% to 2.5% by weight of the amount of polystyrene.

14. A method as set forth in claim 12 wherein said polyethylene is a #2 melt polyethylene in an amount of 1% by weight of the amount of polystyrene.

15. A method as set forth in claim 12 wherein said polyethylene is selected from a #20 melt to #30 melt polyethylene and in an amount of from 1% to 20% by weight of the amount of polystyrene.

16. A method as set forth in claim 12 wherein said polyethylene has a melt number in the melt range of from #20 to #30 and is in an amount of from 1% to 5% by weight of the amount of polystyrene.
